(19) United States
(12) Patent Application Publication
(10) Pub. No.: US 2012/0076673 A1
(43) Pub. Date: Mar. 29, 2012

(54) Mounting Device With Splined Washer

(75) Inventors: Holly Thomas, Morgantown, IN (US); Larry D. Burns, Avon, IN (US); Mark E. Hemphill, Danville, IN (US); Ron A. Wilson, Greenwood, IN (US)

(73) Assignee: CARRIER CORPORATION, Farmington, CT (US)

(21) Appl. No.: 13/322,978

(22) PCT Filed: Mar. 24, 2010
(86) PCT No.: PCT/US10/28423

§ 371 Date: Nov. 29, 2011

Related U.S. Application Data
(60) Provisional application No. 61/184,461, filed on Jun. 5, 2009.

(51) Int. Cl. F04B 53/00; F16B 43/00; F16B 33/00

(52) U.S. Cl. 417/313; 411/368

(57) ABSTRACT

A mounting device mounts a mounting foot to another member, such as a base pan. The mounting device includes a grommet, a splined washer and a fastener. The grommet has an axially extending post for receiving a mounting foot. The splined washer is configured to lock into the mounting foot and the post. The splined washer has an inner bore for receiving the post. The fastener is received on the post and maintains the splined washer and the mounting foot on the post.

### BACKGROUND

Compressors for refrigeration, air conditioning and heat pump systems are typically mounted to a base pan. In order to dampen vibrations and the resultant noise caused by the operation of the compressor, vibration isolating mounting assemblies can be located between the feet of the compressor and the base pan. For example, elastomeric grommets can be located between the feet of the compressor and the base pan to which it is mounted. Elastomeric grommets can have a single post design, as disclosed by U.S. Pat. No. 6,354,558 by Li, or a split post design, as disclosed by U.S. Pat. No. 5,221,192 by Heflin et al.

The single post grommet connects the base pan to the compressor using one grommet stud. The single post grommet receives a base pan, an elastomeric grommet body, a compressor mounting foot, a washer and a nut on a single grommet stud.

In comparison, the split post grommet has two threaded ends that extend from the body of the grommet in opposite directions. The first threaded end attaches the grommet to the base pan. The second threaded end attaches the grommet to the compressor. Mounting feet extend from the compressor, and one compressor mounting foot is placed over the second threaded end. A nut is threadably received on the second threaded end. The nut prevents or limits vertical movement of the compressor mounting foot. The grommets reduce the vibrations transferred from the compressor mounting feet to the base pan, and reduce the noise caused by the operation of the compressor.

### SUMMARY

A mounting device mounts a mounting foot to another member, such as a base pan. The mounting device includes a grommet, a splined washer and a fastener. The grommet has an axially extending post for receiving a mounting foot. The splined washer is configured to lock into the mounting foot and the post. The splined washer has an inner bore for receiving the post. The fastener is received on the post for maintaining the splined washer and the mounting foot on the post.

### BRIEF DESCRIPTION OF THE DRAWINGS

FIG. 1 is a perspective view of a compressor mounted to a base pan by a splined mounting assembly.

FIG. 2 is an enlarged perspective view of a splined mounting assembly having a geared grommet and a geared washer.

FIG. 3 is a cross-sectional view of the splined mounting assembly of FIG. 2 taken along line 3-3.

FIG. 4 is an enlarged top view of the geared grommet of FIG. 2.

FIG. 5 is an enlarged top view of the geared washer of FIG. 2.

FIG. 6 is an enlarged perspective view of a splined mounting assembly having a geared grommet and a press-fit washer.

FIG. 7 is a cross-sectional view of the splined mounting assembly of FIG. 6 taken along line 7-7.

FIG. 8 is an enlarged perspective view of a splined mounting assembly having a keyed grommet and a keyed washer.

FIG. 9 is a cross-sectional view of the splined mounting assembly of FIG. 8 taken along line 9-9.

### DETAILED DESCRIPTION

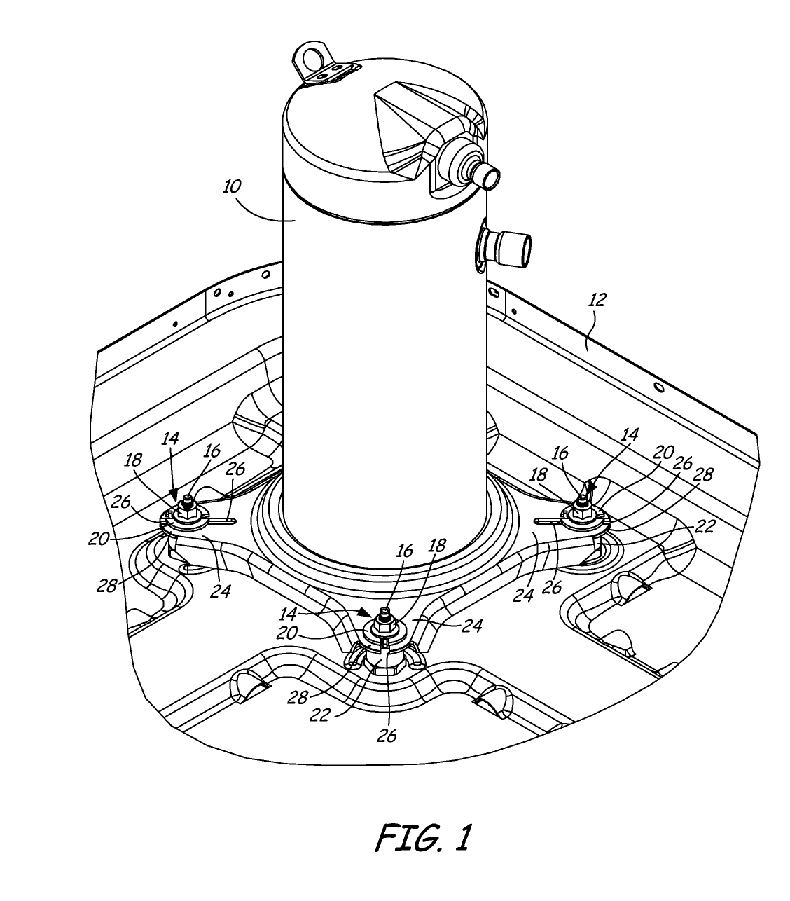

FIG. 1 is a perspective view of a compressor assembly comprising compressor 10, base pan 12 and splined mounting assemblies 14 each of which includes upper post 16, fastener 18, splined washer 20 and grommet body 22. A plurality of compressor mounting feet 24 extend from compressor 10, and each compressor mounting foot 24 includes channel 26 and end 28. Mounting assemblies 14 secure compressor 10 to base pan 12. Upper post 16 extends from grommet body 22 through compressor mounting foot 24 and splined washer 20, and is secured by fastener 18. In one example, upper post 16 can be a grommet stud or a bolt. Splined washer 20 is configured to lock into upper post 16 and compressor mounting foot 24 to prevent the relative motion of upper post 16 and compressor mounting foot 24. Fastener 18 maintains compressor mounting foot 24 and splined washer 20 on upper post 16. Fastener 18 can be a nut or a similar device to maintain compressor mounting foot 24 and splined washer 20 on upper post 16. A lower post (not shown) extends from grommet body 22 opposite upper post 16 and attaches to base pan 12.

Compressor 10 can be any compressor suitable for use in an air conditioning unit or an air handling unit. During operation, compressor 10 produces vibrations and resulting noises. Mounting assemblies 14 vibrationally and acoustically isolate compressor 10 from base pan 12 to reduce vibration and vibration induced noise produced during operation of compressor 10.

Each compressor mounting foot 24 includes channel 26 that extends to end 28 of compressor mounting foot 24. Channel 26 provides additional freedom to compressor mounting foot 24 and assists in eliminating vibration transmission through compressor mounting foot 24 to base pan 12. Compressor mounting foot 24 is not firmly clamped between grommet body 22 and fastener 18, because such clamping negates the benefits of channel 26. Instead, mounting assembly 14 allows vertical motion of compressor mounting foot 24, which assists in eliminating vibration transmissions from compressor mounting foot 24 to base pan 12.

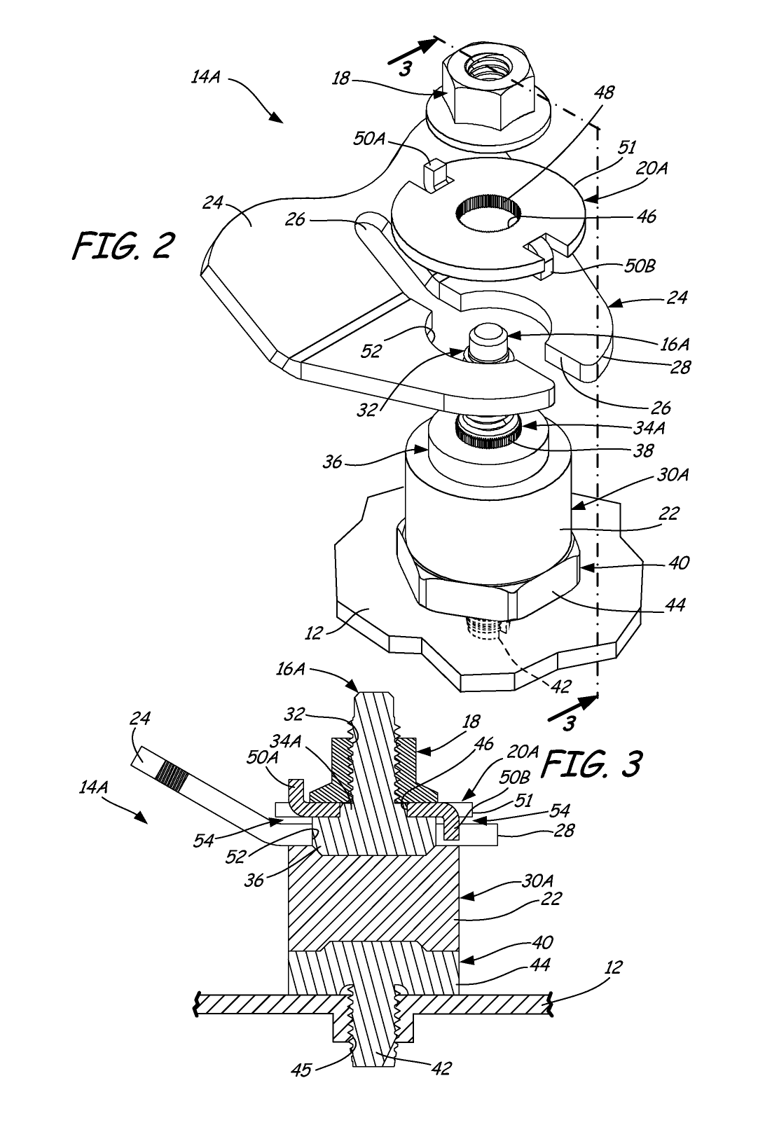

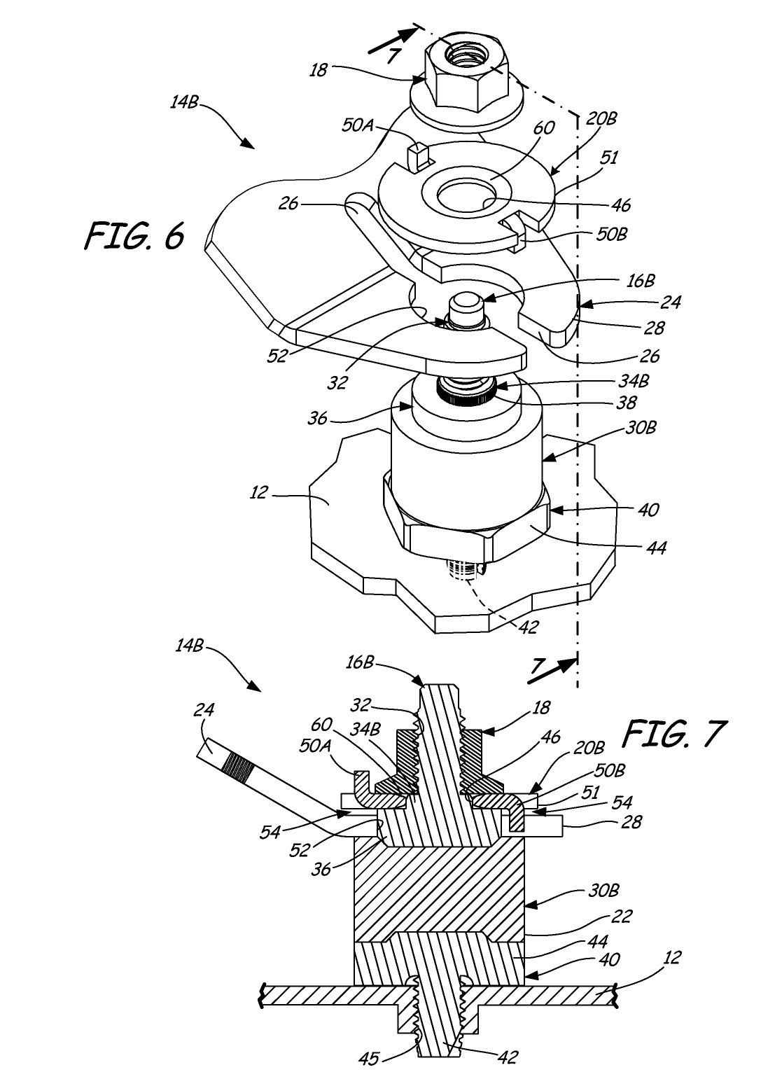

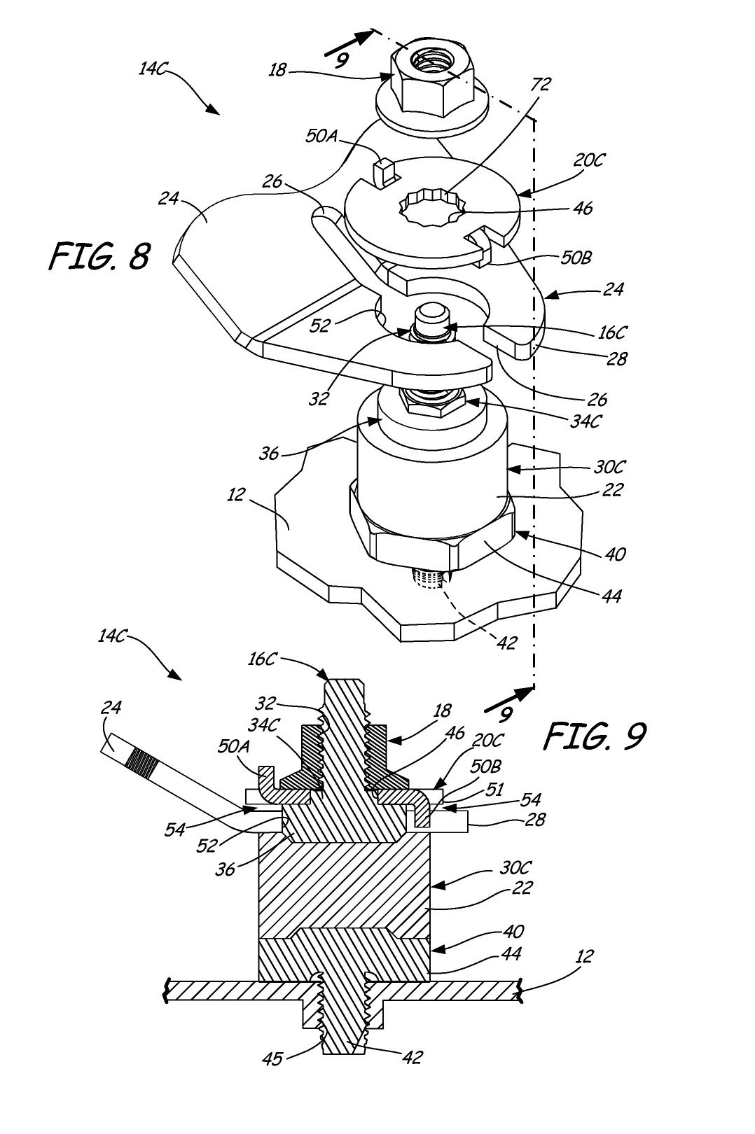

As discussed further below, upper post 16 cannot move relative to compressor mounting foot 24 in splined mounting assembly 14. For example, splined mounting assembly 14 can be geared mounting assembly 14A (shown in FIGS. 2 and 3), interference mounting assembly (shown in FIGS. 6 and 7) or keyed mounting assembly 14C (shown in FIGS. 8 and 9). More specifically, splined washer 20 locks into compressor mounting foot 24 and upper post 16 to prevent the movement of upper post 16 relative to compressor mounting foot 24. The inner bore (not shown in FIG. 1) of splined washer 20 can have different configurations to enable splined washer 20 to lock into upper post 16. For example, splined washer 20 can be a geared washer (as shown in FIGS. 2, 3 and 5), an interference washer (as shown in FIGS. 6 and 7) or a keyed washer (as shown in FIGS. 8 and 9). Additionally, one skilled in the art will recognize that splined washer 20 can have any configuration that allows it to lock into compressor mounting foot 24 and upper post 16.

In one embodiment, splined mounting assembly 14 is a geared mounting assembly, such as geared mounting assembly 14A, and splined washer 20 is a geared washer, such as geared washer 20A. FIG. 2 is an enlarged perspective view of geared mounting assembly 14A, and FIG. 3 is a cross-sectional view of geared mounting assembly 14A taken along line 3-3 of FIG. 2. Geared mounting assembly 14A includes geared grommet 30A, geared washer 20A, compressor mounting foot 24 and fastener 18. Geared grommet 30A includes upper post 16A (having threaded portion 32, geared base 34A and shoulder 36), grommet body 22 and lower post 40 (having threaded portion 42 and head 44). Grommet body 22 is made from an elastomeric or resilient material, such as rubber or neoprene. Upper post 16A and lower post 40 extend from opposite ends of grommet body 22. Grommet body 22 is integrally formed with upper post 16A and lower post 40. For example, geared grommet 30A can be formed by molding rubber between upper post 16A and lower post 40.

Lower post 40 attaches geared grommet 30A to base pan 12 and includes threaded portion 42 and head 44. Lower post 40 is connected to base pan 12 by driving threaded portion 42 through hole 45 in base pan 12. Head 44 allows a wrench to be directly applied to lower post 40 when lower post 40 is attached to base pan 12. This prevents the torque required to drive lower post 40 into place from traveling through grommet body 22.

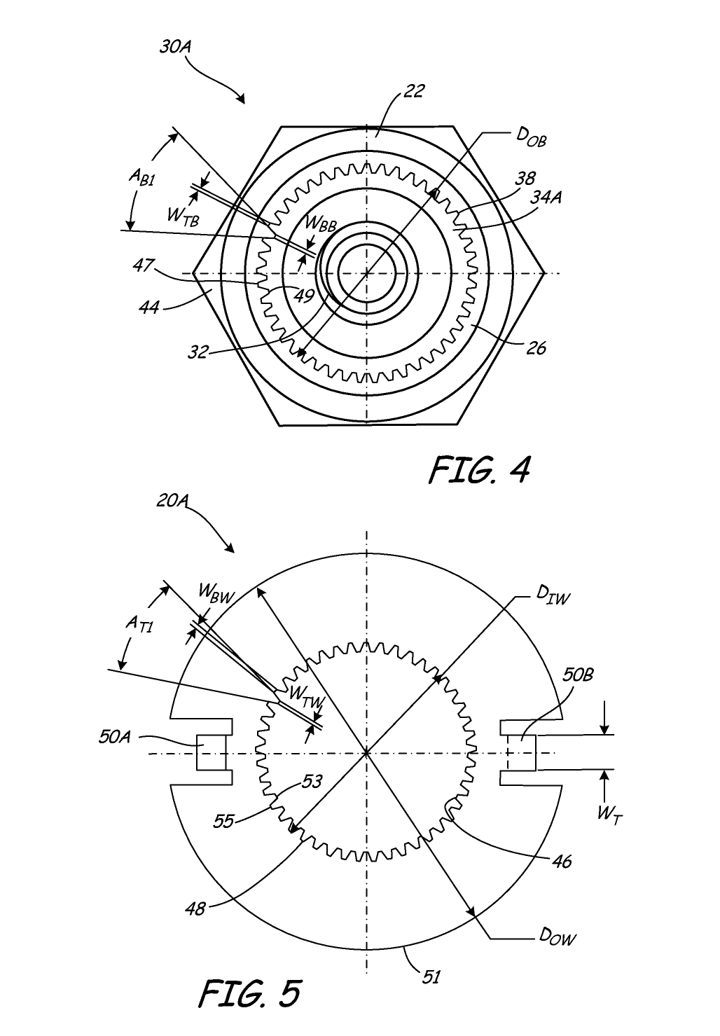

Upper post 16A extends from grommet body 22 opposite of lower post 40 and includes threaded portion 32, geared base 34A and shoulder 36. Threaded portion 32, geared base 34A and shoulder 36 have different diameters. Geared base 34A has a smaller outer diameter than shoulder 36 and a larger diameter than threaded portion 32. Shoulder 36 has a larger outer diameter than threaded portion 32 and geared base 34A and a smaller outer diameter than grommet body 22. In one example, shoulder 36 has an outer diameter of about 18.5 millimeters (mm), geared base 34A has an outer diameter of about 10 mm, threaded portion 32 has an outer diameter of about 6 mm and grommet body has an outer diameter of about 25 mm. Teeth or gears 38 extend radially from geared base 34A. Teeth 38 are described further below with respect to FIG. 4.

Geared washer 20A includes inner bore 46, teeth or gears 48, first key 50A, second key 50B and outer edge 51. A plurality of teeth 48 radially extends from inner bore 46 of geared washer 20A. Teeth 48 compliment teeth 38 of geared base 34, so that teeth 48 and teeth 38 lock together. In one example, forty-five teeth 48 extend from geared washer 20A and forty-five teeth 38 extend from geared base 34A. Teeth 48 are described further below with respect to FIG. 5.

First key 50A and second key 50B (referred to generally as keys 50) radially and vertically extend from outer edge 51 of geared washer 20A. Keys 50 fit or lock into a keyway formed in compressor mounting foot 24. In one example, keys 50 are tabs or fingers that extend from geared washer 20A. Additionally, keys 50 can be any means for locking geared washer 20A to compressor mounting foot 24. First key 50A and second key 50B can extend from geared washer 20A in radially opposite directions. Additionally, first key 50A and second key 50B can extend from geared washer 20A in opposite vertical directions to form a symmetrical design, as described further below. Alternatively, first key 50A and second key 50B can extend from geared washer 20A in the same vertical direction.

A plurality of compressor mounting feet 24 extend from compressor 10. Each compressor mounting foot 24 includes channel 26, bore 52 and end 28. Channel 26 extends to end 28 of compressor mounting foot 24. Channel 26 provides some freedom of motion to compressor mounting foot 24 and reduces vibration transmissions from compressor mounting foot 24 through geared grommet 30A to base pan 12. Channel 26 is sized to accept keys 50. Channel 26 is a keyway which keys 50 fit or lock into. Keys 50 lock into channel 26 and prevent geared washer 20A from moving relative to compressor mounting foot 24.

When geared mounting assembly 14A is assembled, geared grommet 30A receives compressor mounting foot 24, geared washer 20A and fastener 18. Upper post 16A extends through bore 52 of compressor mounting foot 24 and bore 46 of geared washer 20A. Threaded portion 32 of upper post 16A receives fastener 18. Fastener 18 maintains geared washer 20A and compressor mounting foot 24 on geared grommet 30A. Fastener 18 can be a nut or a similar device to maintain compressor mounting foot 24 and geared washer 20A on geared grommet 30A.

Mounting assembly 14A is designed so that compressor mounting foot 24 is not tightly clamped against grommet 30A. The diameter of bore 52 of compressor mounting foot 24 is larger than the outer diameter of shoulder 36 and smaller than the outer diameter of grommet body 22 so that compressor mounting foot 24 rests on grommet body 22. In one example, shoulder 36 is configured to substantially fill bore 52. The inner diameter of geared washer 20A is smaller than the outer diameter of shoulder 36 and about equal to the outer diameter of geared base 34A of upper post 16A so that geared washer 20A sits on shoulder 36. Shoulder 36 acts as a positive stop and prevents compressor mounting foot 24 from being clamped tightly to grommet body 22. As shown in FIG. 3, shoulder 36 is thicker than compressor mounting foot 24 so that gap 54 is formed between compressor mounting foot 24 and geared washer 20A. Gap 54 prevents geared washer 20A and fastener 18 from tightly clamping compressor mounting foot 24 to grommet body 22. Gap 54 provides a small amount of clearance between compressor mounting foot 24 and geared washer 20A, and allows some vertical motion of compressor mounting foot 24. In one example, shoulder 36 is between about 4 and 5 mm thick and compressor mounting foot 24 is between about 3 and 3.5 mm thick. In another example, gap 54 is between about 1 and 1.5 mm thick.

Geared washer 20A is a splined washer that locks into geared grommet 30A and compressor mounting foot 24. Geared washer 20A locks geared grommet 30A and compressor mounting foot 24 together so that geared grommet 30A cannot move relative to compressor mounting foot 24. Geared washer 20A separately locks into geared grommet 30A and compressor mounting foot 24. Geared washer 20A locks into geared grommet 30A using teeth 48. Bore 46 and teeth 48 of geared washer 20A are compatible with or complementary to the outer diameter and teeth 38 of geared base 34A so that geared washer 20A fits on and locks onto geared base 34A. Geared washer 20A locks into grommet 30A and prevents the movement of geared washer 20A and geared grommet 30A relative to one another.

Geared washer 20A locks into compressor mounting foot 24 using one of keys 50. Keys 50 of geared washer 20A are compatible with or complementary to channel 26 of compressor mounting foot 24. As shown, second key 50B extends downwards towards compressor mounting foot 24. When geared washer 20A is in place, second key 50B extends through the keyway formed by channel 26 of compressor mounting foot 24 and locks geared washer 20A into compressor mounting foot 24. Therefore, geared washer 20A and compressor mounting foot 24 lock together and the movement of geared washer 20A and compressor mounting foot 24 relative to one another is prevented.

As described above, first key 50A and second key 50B on geared washer 20A can extend in opposite vertical directions to form a symmetrical design. When symmetrical, one of keys 50 will be positioned downwards towards compressor mounting foot 24 no matter which direction geared washer 20A is assembled on upper post 16A. Thus, geared washer 20A provides a foolproof assembly.

During assembly, fastener 18 is tightened onto upper post 16A by a torque device when, for example, fastener 18 is a nut. In geared mounting assembly 14A, there is nothing to tighten fastener 18 against because of gap 54. Without geared washer 20A, torsion is applied to grommet 30A when fastener 18 reaches the bottom of threaded portion 32 (i.e. the nut bottoms out). At high torque levels, the torsion can be destructive to grommet 30A, and can cause grommet 30A to rip or tear out.

Locking geared washer 20A into geared grommet 30A and compressor mounting foot 24 increases the torque value of the mounting assembly, and allows a greater amount of torque to be applied to fastener 18 without destructively twisting geared grommet 30A. Geared washer 20A locks to geared grommet 30A and compressor mounting foot 24 so that geared grommet 30A does not move as fastener 18 is tightened onto geared grommet 30A. Locking geared grommet 30A and compressor mounting foot 24 together prevents geared grommet 30A from ripping or twisting. Geared mounting assembly 14A having geared washer 20A and geared grommet 30A prevents grommets from tearing out at high torque values during assembly at the factory, which prevents down time of the assembly line. Further, geared mounting assembly 14A allows higher torque values to be used during disassembly of geared mounting assembly 14A. For example, high torque values can be used when removing fastener 18 from upper post 16A during removal of compressor 10.

Teeth 38 and teeth 48 that lock geared washer 20A to geared grommet 30A are further illustrated in FIGS. 4 and 5, which are enlarged top views of geared grommet 30A and geared washer 20A, respectively. In FIG. 4, geared base 34A has outer diameter D_{OB} and a plurality of teeth 38 extending radially outwards. Teeth 38 each have top land 47 (having top land width W_{TB}) and bottom land 49 (having bottom land width W_{BB}). Angle A_{B1} is formed between teeth 38. Teeth 38 are symmetrical.

As shown in FIG. 5, geared washer 20A has inner diameter D_{IW}, outer diameter D_{OW}, keys 50A and 50B (having width W_{T}) and a plurality of teeth 48 extending radially inward from bore 46. Teeth 48 each have top land 53 (having top land width W_{TW}) and bottom land 55 (having bottom land width W_{BW}). Angle A_{T1} is formed between teeth 48. Teeth 48 are symmetrical.

Teeth 38 are complementary to teeth 48. In one example, inner diameter D_{IW} of geared washer 20A and outer diameter D_{OB} of geared base 34A are about equal; angles A_{TB} and A_{WT} are about equal; and top land width W_{TB} of geared base 34A, bottom land width W_{BB} of geared base 34A, top land width W_{TW} of geared washer 20A and bottom land width W_{BW} of geared washer 20A are about equal. In another example, inner diameter D_{IW} of geared washer 20A and outer diameter D_{OB} of geared base 34A are about 16.4 mm; angles A_{TB} and A_{WT} are about 45 degrees; and top land width W_{TB} of geared base 34A, bottom land width W_{BB} of geared base 34A, top land width W_{TW} of geared washer 20A and bottom land width W_{BW} of geared washer 20A are about 0.3 mm. As described, geared washer 20A is complementary to geared base 34A so that geared washer 20A locks into geared base 34A and prevents the movement of geared grommet 30A relative to geared washer 20A. Geared mounting assembly 14A is one embodiment of a splined mounting assembly.

In another embodiment, splined mounting assembly 14 is an interference mounting assembly, such as interference mounting assembly 14B, and splined washer 20 is an interference washer, such as interference washer 20B. FIG. 6 is an enlarged perspective view of interference mounting assembly 14B, and FIG. 7 is a cross-sectional view of interference mounting assembly 14B of FIG. 6 taken along line 7-7. Interference mounting assembly 14B is a splined mounting assembly similar to geared mounting assembly 14A of FIG. 2 and FIG. 3 except that geared washer 20A is replaced with interference washer 20B. Interference mounting assembly 14B includes geared grommet 30B, compressor mounting foot 24, fastener 18 and interference washer 20B. Compressor mounting foot 24 and fastener 18 are similar to those described above with respect to geared mounting assembly 14A. Geared grommet 30B is similar to geared grommet 30A described above. Geared grommet 30B includes upper post 16B (having threaded portion 32, geared base 34B and shoulder 36), grommet body 22 and lower post 40 (having threaded portion 42 and head 44).

Interference washer 20B is a splined washer that locks into compressor mounting foot 24 and geared grommet 30B. Friction between interference washer 20B and geared grommet 30B locks the parts together. In one example, interference washer 20B is a press fit washer.

Interference washer 20B is formed from a material having a hardness less than that of upper post 16B. In one example, interference washer 20B can be formed of a soft metal. In another example, interference washer 20B is a zinc die cast. Interference washer 20B is formed so that bore 46 is slightly smaller than the outer diameter of geared base 34B. When interference washer 20B is pressed onto geared base 34B, there is an interference and the friction between geared base 34B and interference washer 20B fastens them together. For example, when interference washer 20B is pressed onto geared base 34B of upper post 16B, teeth complimentary to teeth 38 of geared base 34B can be formed on interference washer 20B at bore 46. The teeth formed on bore 46 compliment teeth 38 of geared base 34B so that interference washer 20B locks into geared grommet 30B.

Interference washer 20B has tapered portion 60 adjacent bore 46. As shown in FIG. 7, the thickness of interference washer 20B gradually decreases in tapered portion 60 so that the thickness of interference washer 20B is less at bore 46 than at outer edge 51. In one example, interference washer 20B has a thickness of about 2 mm at outer edge 51 and a thickness of about 1 mm at bore 46. Tapered portion 60 is a lead in, which makes it easier for teeth to be formed in interference washer 20B.

First key 50A and second key 50B (referred to generally as keys 50) extend radially and vertically from interference washer 20B. Keys 50 fit into a keyway formed in compressor mounting foot 24 to lock compressor mounting foot 24 to interference washer 20B. First key 50A and second key 50B extend in vertically opposite directions so that interference washer 20B has a symmetrical design, which provides foolproofing for assembly. Alternatively, keys 50 can extent in the same vertical direction.

When interference mounting assembly 14B is assembled, upper post 16B extends through bore 52 of compressor mounting foot 24, and compressor mounting foot 24 rests on grommet body 22. Upper post 16B also extends through interference washer 20B, and fastener 18 is threadably received on upper post 16B. Bore 52 of compressor foot 24 is smaller than the outer diameter of grommet body 22 so that compressor foot 24 sits on grommet body 22. Bore 46 of interference washer 20B is smaller than the outer diameter of shoulder 36 so that interference washer 20B sits on shoulder 36. As seen in the cross-sectional view of FIG. 7, shoulder 36 is thicker than compressor mounting foot 24. Shoulder 36 is a positive stop that prevents interference washer 20B and fastener 18 from tightly clamping compressor mounting foot 24 to grommet body 22. Gap 54 is formed between compressor mounting foot 24 and interference washer 20B. In one example, gap 54 is between about 1 to 1.5 mm thick. Gap 54 allows compressor mounting foot 24 some vertical movement and prevents the transfer of vibrations from compressor mounting foot 24, through geared grommet 30B to base pan 12.

A torque device is used to apply torque to fastener 18 during assembly of mounting assembly 14B when, for example, fastener 18 is a nut. As described above, because of gap 54, there is no object to tighten fastener 18 against. As a result, when fastener 18 reaches the bottom of threaded portion 32, the torque device will continue to apply torque on fastener 18 and grommet 30B. Without interference washer 20B, this torque will twist geared grommet 30B. At high torque values, destructive torsion can be applied to geared grommet 30B, which can cause geared grommet 30B to rip or tear out. Interference mounting assembly 14B prevents the twisting of and the application of the destructive torsion on geared grommet 30B by locking interference washer 20B into geared grommet 30B and compressor mounting foot 24. By locking into geared grommet 30B and compressor mounting foot 24, interference washer 20B prevents the movement of geared grommet 30B relative to compressor mounting foot 24 and increases the torque value of geared grommet 30B.

Interference washer 20B locks into geared grommet 30B by forming teeth on bore 46 that are compatible with or complementary to teeth 38 of geared grommet 30B. When interference washer 20B is pressed onto geared base 34B, the softer (i.e. lower hardness) material of interference washer 20B forms around teeth 38, thus locking interference washer 20B into geared grommet 30B.

Interference washer 20B locks into compressor mounting foot 24 using one of keys 50. As illustrated in FIG. 6, second key 50B extends from interference washer 20B towards compressor mounting foot 24 and fits into the keyway formed by channel 26. As described above, keys 50 can extend in vertically opposite directions to provide foolproofing for assembly. No matter which direction interference washer 20B is received on upper post 16B, one of keys 50 will extend towards and lock into channel 26.

In a further embodiment, splined mounting assembly 14 is a keyed mounting assembly, such as keyed mounting assembly 14C, and splined washer 20 is a keyed washer, such as keyed washer 20C. FIGS. 8 and 9 are perspective and cross-sectional views of keyed mounting assembly 14C, respectively. Keyed mounting assembly 14C includes keyed grommet 30C, keyed washer 20C and fastener 18. Keyed grommet 30C includes upper post 16C (having threaded portion 32, keyed base 34C and shoulder 36), grommet body 22 and lower post 40 (having threaded portion 42 and head 44). Grommet body 22 is formed of an elastomeric or resilient material such as rubber. Upper post 16C and lower post 40 extend from grommet body 22 in opposite directions. Upper post 16C and lower post 40 are integrally formed with grommet body 22 such as by molding. Grommet body 22 has a larger outer diameter than upper post 16C.

Lower post 40 attaches keyed grommet 30C to base pan 12 and includes threaded portion 42 and head 44. As described above, lower post 40 is connected to base pan 12 by driving threaded portion 42 through hole 45 in base pan 12. Head 44 allows a wrench to be directly applied to lower post 40 so that torque does not travel through grommet body 22 when lower post 40 is attached to base pan 12.

Upper post 16C includes threaded portion 32, keyed base 34C and shoulder 36. Upper post 16C is similar to upper post 16B of FIGS. 6 and 7 except geared base 34B is replaced with keyed base 34C. Keyed base 34C has a shape that compliments keyed washer 20C as described further below. Keyed base 34C, threaded portion 32 and shoulder 36 have different diameters. Keyed base 34C has a larger diameter than threaded portion 32 and a smaller diameter than shoulder 36. Shoulder 36 has a larger diameter than threaded portion 32 and a smaller diameter than grommet body 22.

Keyed washer 20C includes bore 46, first key 50A and second key 50B. Keyed washer 20C is a splined washer that locks onto compressor mounting foot 24 and keyed grommet 30C as described further below. Key notches 72 extend from bore 46. The shape of bore 46 compliments or is compatible with the shape of keyed base 34C. In this way, keyed washer 20C locks into keyed grommet 30C. In one example, bore 46 and keyed base 34C have a hexagonal shape. In another example, bore 46 and keyed base 34C have complimentary, non-circular shapes. The complimentary, non-circular shapes of bore 46 and base 34C locks keyed washer 20C into keyed grommet 30C, and prevents grommet 30C from moving relative to washer 20C. For example, bore 46 and keyed base 34C can both have triangular, hexagonal or octagonal shapes.

First key 50A and second key 50B extend radially from keyed washer 20C. Keys 50 lock keyed washer 20C into a keyway formed in compressor mounting foot 24. Keys 50 can be tabs, fingers or other suitable means for locking washer 20C into compressor mounting foot 24.

As shown in FIG. 8, first key 50A extends away from compressor mounting foot 24, and second key 50B extends towards compressor mounting foot 24. First key 50A and second key 50B are sized to fit in a keyway formed by channel 26 of compressor mounting foot 24 so that keys 50 can lock into channel 26. By extending in opposite vertical directions, first key 50A and second key 50B form a symmetrical design. That is, one of keys 50 can lock into channel 26 regardless of which direction keyed washer 20C is assembled on grommet 30C.

When mounting assembly 14C is assembled, compressor mounting foot 24 is received on upper post 16C of keyed grommet 30C, followed by keyed washer 20C. Fastener 18 is threadably received on threaded portion 32 of upper post 16C. Bore 52 of compressor mounting foot 24 has a larger diameter than shoulder 36 and a smaller diameter than grommet body 22 so that compressor mounting foot 24 sits on grommet body 22. Similarly, keyed washer 20C has a larger diameter than threaded portion 32 of upper post 16C and a smaller diameter than shoulder 36 so that keyed washer 20C sits on shoulder 36.

As shown in the cross-sectional view of FIG. 9, shoulder 36 is thicker than compressor mounting foot 24. This creates gap 54 between compressor mounting foot 24 and keyed washer 20C, and prevents keyed washer 20C and fastener 18 from clamping compressor mounting foot 24 to grommet body 22. In one example, gap 54 is between about 1 and 1.5 mm thick so that there is about 1 to 1.5 mm of clearance between keyed washer 20C and compressor mounting foot 24. Gap 54 allows some vertical motion of compressor mounting foot 24. Gap 54 also prevents vibrations from transferring from compressor mounting foot 24 to base pan 12 through grommet 30C. Thus, keyed mounting assembly 14C reduces the noises generated during the operation of compressor 10.

As described above, a torque device can be used during assembly to tighten fastener 18 on upper post 16C, such as when fastener 18 is a nut. However, because of gap 54, there is nothing to tighten fastener 18 against. With nothing to tighten fastener 18 against, the torque device will continue to apply torque on fastener 18 and grommet 30C after fastener 18 has reached the bottom of threaded portion 32. Without keyed washer 20C, torsion is applied to grommet 30C which twits grommet 30C. At high torque values, destructive torsion can be applied to grommet 30C, which causes grommet 30C to rip or tear out.

Keyed washer 20C increases the torque value of the mounting assembly. To prevent grommet 30C from twisting, keyed washer 20C locks into grommet 30C and compressor mounting foot 24. Bore 52 of keyed washer 20C locks onto keyed base 34C of grommet 30C and second key 50B locks into channel 26 of compressor mounting foot 24. Keyed washer 20C prevents radial movement of grommet 30C when torque is applied to fastener 18, such as when fastener 18 is attached to upper post 16C. This is especially beneficial when high torque is used during assembly of mounting assembly 14C.

Tests show that the inclusion of splined washer 20, such as geared washer 20A (shown in FIGS. 2, 3 and 5), interference washer 20B (shown in FIGS. 6 and 7) or keyed washer 20C (shown in FIGS. 8 and 9), in a mounting assembly where the compressor mounting foot is not tightly clamped against the grommet, increases the torque value of the grommet. For example, a torque greater than about 4.5 Newton meter (Nm) (40 inch-pound force) can destroy a grommet in a mounting assembly not having a splined washer and wherein the compressor foot is not tightly clamped. When splined washer 20, such as geared washer 20A, interference washer 20B or keyed washer 20C, is locked into compressor mounting foot 24 and grommet 30 (such as grommet 30A, 30B or 30C), grommet 30 can withstand torque values of between about 11 Nm to about 14 Nm (about 100 to about 125 inch-pound force) without failure. Thus, splined washer 20 increases the torque value of grommet 30. Additionally, the use of splined washer 20 will decrease the assembly line down time due to grommet rip out, and will reduce the amount of grommets destroyed during disassembly (i.e. when the compressor is removed from the base pan). Splined mounting assemblies 14, such as geared mounting assembly 14A (shown in FIGS. 2 and 3), interference mounting assembly 14B (shown in FIGS. 6 and 7) and keyed mounting assembly 14C (shown in FIGS. 8 and 9), experience a reduced number of grommet failures during assembly and disassembly.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A mounting device comprising:
a grommet having an axially extending post for receiving a mounting foot;
a splined washer configured to lock into the mounting foot and the post, the splined washer having an inner bore for receiving the post; and
a fastener received on the post for maintaining the splined washer and the mounting foot on the post.

2. The mounting device of claim 1, wherein the inner bore of the splined washer further comprises teeth, and wherein the grommet further comprises teeth that are complimentary to the teeth of the splined washer.

3. The mounting device of claim 2, wherein the mounting foot comprises a keyway, and wherein the splined washer further comprises a key configured to lock into the keyway on the mounting foot.

4. The mounting device of claim 1, wherein the inner bore of the splined washer has a non-circular shape, and wherein the grommet further comprises a base having a non-circular shape that is complimentary to the inner bore of the splined washer.

5. The mounting device of claim 4, wherein the splined washer further comprises a tab configured to lock into the mounting foot.

6. The mounting device of claim 1, wherein the grommet further comprises teeth, and wherein the splined washer is an interference washer.

7. The mounting device of claim 6, wherein the splined washer further comprises a tab configured to lock into the mounting foot.

8. The mounting device of claim 1, and further comprising a gap between the mounting foot and the splined washer.

9. An air handling unit comprising:
a base pan;
a compressor mounted to the base pan, the compressor having a mounting foot;
a grommet for mounting the compressor to the base pan, the grommet having a lower post, a middle section, an upper post and a base, the lower post extending from a first end of the middle section for connecting to the base pan, the upper post extending from a second end of the middle section for receiving the mounting foot, and the base located between the upper post and the middle section;
a splined washer having an inner bore, the splined washer configured to lock into the grommet and the mounting foot so that the grommet cannot move relative to the mounting foot; and
a fastener received on the upper post for maintaining the mounting foot and the splined washer on the upper post.

10. The air handling unit of claim 9, wherein the inner bore of the splined washer comprises teeth, and wherein the base comprises teeth that are compatible with the teeth of the splined washer.

11. The air handling unit of claim 9, wherein the base comprises teeth, and wherein the washer is an interference washer.

12. The air handling unit of claim 9, wherein the base has a non-circular shape, and wherein the inner bore of the splined washer has a non-circular shape that is complimentary to the non-circular shape of the base.

13. The air handling unit of claim 9, wherein the splined washer further comprises a key, and wherein the mounting foot further comprises a keyway that is compatible with the key so that the key locks the splined washer onto the mounting foot.

14. A compressor assembly comprising:
a compressor;
a mounting foot extending from the compressor; and
a splined mounting assembly connected to the mounting foot, the mounting assembly comprising:
a grommet having an axially extending post for receiving the mounting foot;
a splined washer configured to lock into the mounting foot and the post, the splined washer having an inner bore for receiving the post; and
a fastener received on the post for maintaining the splined washer and the mounting foot on the post.

15. The compressor assembly of claim 14, wherein the inner bore of the splined washer further comprises teeth, and wherein the grommet further comprises teeth that are complimentary to the teeth of the splined washer.

16. The compressor assembly of claim 15, wherein the mounting foot comprises a keyway, and wherein the splined washer further comprises a key configured to lock into the keyway on the mounting foot.

17. The compressor assembly of claim 14, wherein the inner bore of the splined washer has a non-circular shape, and wherein the grommet further comprises a base having a non-circular shape that is complimentary to the inner bore of the splined washer.

18. The compressor assembly of claim 18, wherein the splined washer further comprises a tab configured to lock into the mounting foot.

19. The compressor assembly of claim 14, wherein the grommet further comprises teeth, and wherein the splined washer is an interference washer.

20. The compressor assembly of claim 19, wherein the splined washer further comprises a tab configured to lock into the mounting foot.
